(19) United States
(12) Patent Application Publication
(10) Pub. No.: US 2023/0401109 A1
(43) Pub. Date: Dec. 14, 2023

(54) LOAD BALANCER

(71) Applicant: Intel Corporation, Santa Clara, CA (US)

(72) Inventors: Niall D. MCDONNELL, Limerick (IE); Ambalavanar ARULAMBALAM, Center Valley, PA (US); Te Khac MA, Allentown, PA (US); Surekha PERI, Austin, TX (US); Pravin PATHAK, Bridgewater, NJ (US); James CLEE, Orefield, PA (US); An YAN, Orefield, PA (US); Steven POLLOCK, Allentown, PA (US); Bruce RICHARDSON, Shannon, Clare (IE); Vijaya Bhaskar KOMMINENI, Austin, TX (US); Abhinandan GUJJAR, Bangalore (IN)

(21) Appl. No.: 18/237,860

(22) Filed: Aug. 24, 2023

(30) Foreign Application Priority Data
Jun. 27, 2023 (IN) 202341043060

(51) Int. Cl. G06F 9/50

(52) U.S. Cl. CPC G06F 9/5083; G06F 9/5038

(57) ABSTRACT

Examples described herein relate to a load balancer that is configured to selectively perform ordering of requests from the one or more cores, allocate the requests into queue elements prior to allocation to one or more receiver cores of the one or more cores to process the requests, and perform two or more operations of: adjust a number of queues associated with a core of the one or more cores by changing a number of consumer queues (CQs) allocated to a single domain, adjust a number of target cores in a group of target cores to be load balanced, and order memory space writes from multiple caching agents (CAs).

### RELATED APPLICATION

This application claims priority from Indian Provisional Patent Application No. 202341043060, entitled “LOAD BALANCER,” filed Jun. 27, 2023, in the Indian Patent Office. The entire contents of the Indian Provisional Patent Application are incorporated by reference in its entirety.

### BACKGROUND

Packet processing applications can provision a number of worker processing threads running on processor cores (e.g., worker cores) to perform the processing work of the applications. Worker cores consume packets from dedicated queues, which in some scenarios, are supplied with packets by one or more network interface controllers (NICs) or by input/output (I/O) threads. The number of worker cores provisioned is usually a function of the maximum predicted throughput. However, real packet traffic varies widely both in short durations (e.g., seconds) and over longer periods of time. For example, networks can experience significantly less traffic at night or on a weekend.

Power savings can be obtained if some worker cores can be put in a low power state when the traffic load allows. Alternatively, worker cores that do not perform packet processing operations can be redirected to perform other tasks (e.g., used in other execution contexts) and recalled when processing loads increase.

### BRIEF DESCRIPTION OF THE DRAWINGS

FIG. 1A depicts an example load balancer.

FIG. 1B depicts an example load balancer flow.

FIG. 2 depicts an example of ATOMIC and ORDERED operations of a load balancer.

FIG. 3 depicts an example of processing of outbound communications that contain 3 pipe stages.

FIG. 4 depicts an example of processing of outbound communications that merges 2 pipe stages together.

FIG. 5 depicts an example of combined ATOMIC and ORDERED flow processing.

FIG. 6 depicts an example overview of ATOMIC, ORDERED and combined ATOMIC ORDERED processing.

FIG. 7 depicts an example overview of power aware load balancing.

FIG. 8 depicts an example use case.

FIG. 9 depicts an example of overview of paired CQ mode.

FIG. 10 depicts an example system.

FIG. 11 depicts an example system.

FIG. 12 depicts an example system.

FIG. 13 depicts a load balancer descriptor.

FIG. 14 depicts an example of buffer management of a packet buffer.

FIG. 15 depicts an example of buffer allocations.

FIG. 16 depicts an example system.

FIG. 17 depicts an example of a load balancer operation.

FIG. 18 depicts an example process.

FIG. 19 depicts an example system.

### DETAILED DESCRIPTION

Load balancer circuitry can be used to allocate work among worker cores to attempt to reduce latency of completion of work, while attempting to save power. Load balancer circuitry can support communications between processing units and/or cores in a multi-core processing unit (also referred to as “core-to-core” or “C2C” communications) and may be used by computer applications such as packet processing, high-performance computing (HPC), machine learning, and so forth. C2C communications may include requests to send and/or receive data or read or write data. For example, a first core (e.g., a producer core) may generate a C2C request to send data to a second core (e.g., a consumer core) associated with one or more consumer queues (CQs).

A load balancer can include a hardware scheduling unit to process C2C requests. The processing units or cores may be grouped into various classes, with a class assigned a particular proportion of the C2C scheduling bandwidth. In some examples, a load balancer can include a credit-based arbiter to select classes to be scheduled based on stored credit values. The credit values may indicate how much scheduling bandwidth a class has received relative to its assigned proportion. Load balancer may use the credit values to schedule a class with its respective proportion of C2C scheduling bandwidth. A load balancer can be implemented as an Intel® hardware queue manager (HQM), Intel® Dynamic Load Balancer (DLB), or others.

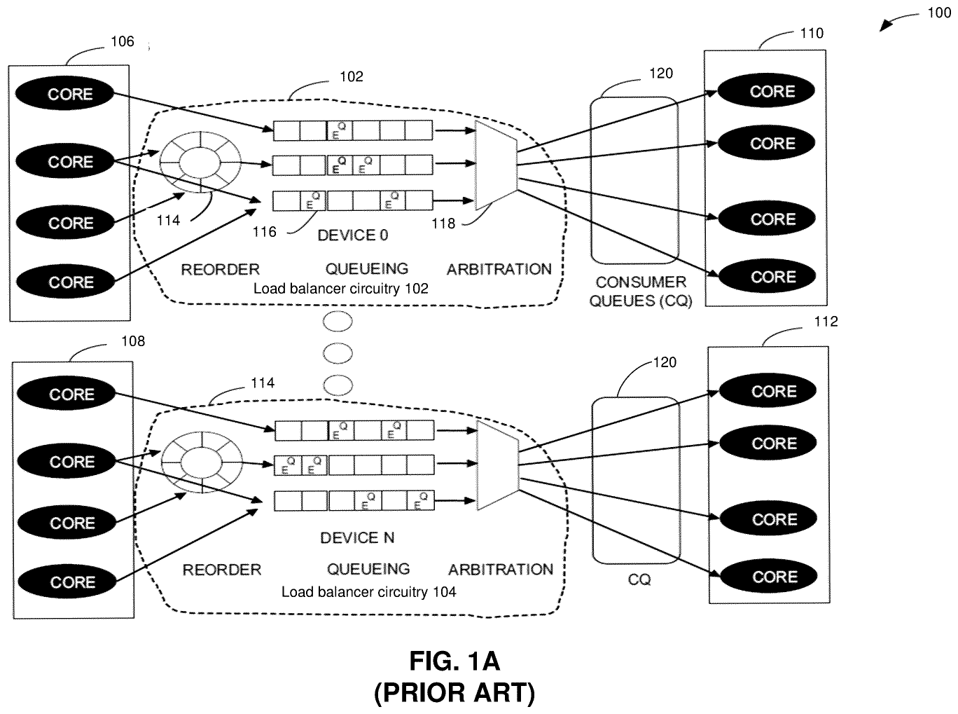

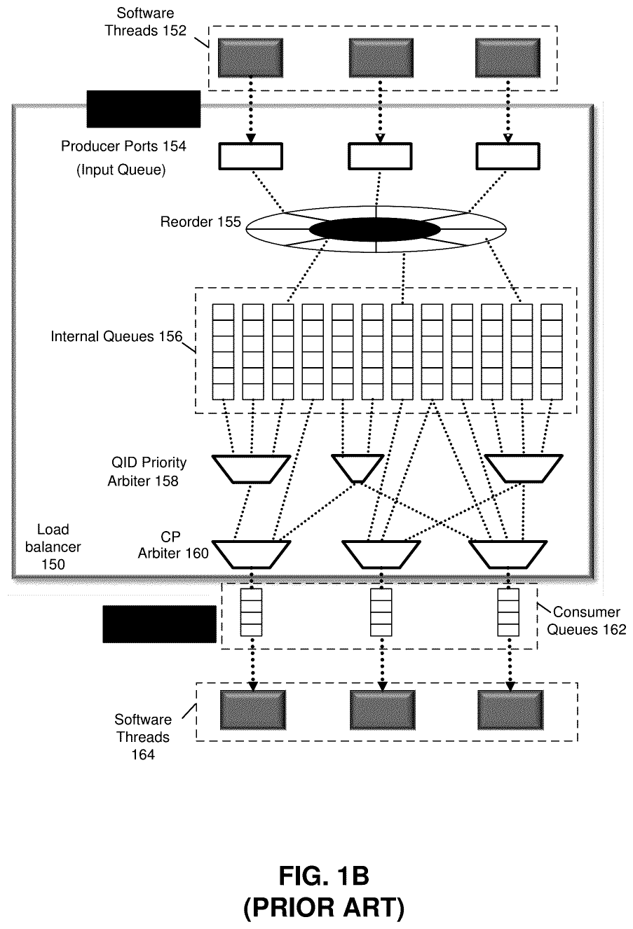

FIG. 1A depicts an example load balancer. In some examples, load balancer circuitry 100 can include one or more of load balancer circuitry 102 and load balancer circuitry 104, although other circuitries can be used. In some examples, producer cores 106 and producer cores 108 can communicate with a respective one of load balancer circuitry 102, 104. In some examples, consumer cores 110 and consumer cores 112 can communicate with a respective one of circuitry 102, 104. In some examples, fewer or more than instances of load balancer circuitry 102, 104 and/or fewer or more than producer cores 106, 108 and/or consumer cores 110, 112 can be used.

In some examples, load balancer circuitry 102, 104 correspond to a hardware-managed system of queues and arbiters that link the producer cores 106, 108 and consumer cores 110, 112. In some examples, one or both of load balancer circuitry 102, 104 can be accessible as a Peripheral Component Interconnect express (PCIe) device.

In some examples, load balancer circuitry 102, 104 can include example reorder circuitry 114, queueing circuitry 116, and arbitration circuitry 118. In some examples, reorder circuitry 114, queueing circuitry 116, and/or arbitration circuitry 118 can be implemented as hardware. In some examples, reorder circuitry 114, queueing circuitry 116, and/or arbitration circuitry 118 can be implemented by hardware, software, firmware and/or any combination of hardware, software and/or firmware.

In some examples, reorder circuitry 114 can obtain data from one or more of the producer cores 106, 108 and facilitate reordering operations based on the data. For example, reorder circuitry 114 can inspect a data pointer from one of the producer cores 106, 108. In some examples, reorder circuitry 114 can determine that the data pointer is associated with a data sequence. In some examples, producer cores 106, 108 can enqueue the data pointer with the queueing circuitry 116 because the data pointer is not associated with a known data flow and may not be needed to be reordered and/or otherwise processed by reorder circuitry 114.

In some examples, reorder circuitry 114 can store the data pointer and other data pointers associated with data packets in the data flow in a buffer (e.g., a ring buffer, a first-in first-out (FIFO) buffer, etc.) until a portion of or an entirety of the data pointers in connection with the data flow are read and/or identified. In some examples, reorder circuitry 114 can transmit the data pointers to one or more of the queues controlled by the queueing circuitry 116 to maintain an order of the data sequence. For example, the queues can store the data pointers as queue elements (QEs).

Queueing circuitry 116 can include a plurality of queues or buffers to store data pointers or other information. In some examples, queueing circuitry 116 can transmit data pointers in response to filling an entirety of the queue(s). In some examples, queueing circuitry 116 transmits data pointers from one or more of the queues to arbitration circuitry 118 on an asynchronous or synchronous basis.

In some examples, arbitration circuitry 118 can be configured and/or instantiated to perform an arbitration by selecting a given one of consumer cores 110, 112. For example, arbitration circuitry 118 can include and/or implement one or more arbiters, sets of arbitration circuitry (e.g., first arbitration circuitry, second arbitration circuitry, etc.), etc. In some examples, respective ones of the one or more arbiters, the sets of arbitration circuitry, etc., can correspond to a respective one of consumer cores 110, 112. In some examples, arbitration circuitry 118 can perform operations based on consumer readiness (e.g., a consumer core having space available for an execution or completion of a task), task availability, etc. In an example operation, arbitration circuitry 118 can execute and/or carry out a passage of data pointers from queueing circuitry 116 to example consumer queues 120.

In some examples, consumer cores 110, 112 can communicate with consumer queues 120 to obtain data pointers for subsequent processing. In some examples, a length (e.g., a data length) of one or more of consumer queues 120 can be programmable and/or otherwise configurable. In some examples, circuitry 102, 104 can generate an interrupt (e.g., a hardware interrupt) to one(s) of consumer cores 110, 112 in response to a status, a change in status, etc., of consumer queues 120. Responsive to the interrupt, the one(s) of consumer cores 110, 112 can retrieve the data pointer(s) from consumer queues 120.

In some examples, circuitry 102, 104 can check a status (e.g., a status of being full, not full, not empty, partially full, partially empty, etc.) of consumer queues 120. In some examples, load balancer circuitry 102, 104 can track fullness of consumer queues 120 by observing enqueues on an associated producer port (e.g., a hardware port) of load balancer circuitry 102, 104. For example, in response to an enqueuing, load balancer circuitry 102, 104 can determine that a corresponding one of consumer cores 110, 112 has completed work on and/or associated with a QE and, thus, a location of the QE is available in the queues controlled by the queueing circuitry 116. For example, a format of the QE can include a bit that is indicative of whether a consumer queue token (or other indicia or datum), which can represent a location of the QE in consumer queues 120, is being returned. In some examples, new enqueues that are not completions of prior dequeues do not return consumer queue tokens because there is no associated entry in consumer queues 120.

FIG. 1B depicts an example load balancer flow. Software threads 152 can provide work requests to producer ports 154 of load balancer 150. Reorder circuitry 155 can reorder work requests based on time of receipt to provide work requests first-in-first-out to internal queues 156. Queue identifier (QID) priority arbiter 158 can arbitrate among work requests and provide work requests for output to consumer port (CP) arbiter 160. CP arbiter 160 can provide work requests to consumer queues 162 for processing by one or more software threads 164.

Discussion next turns to various examples of uses of load balancer. Load balancers described at least with respect to FIGS. 1A and 1B can be modified to include circuitry, processor-executed software, and/or firmware to perform operations described herein under one or more other sub-headings. Various examples described with respect to content under sub-headings can be combined with examples described with respect to content under one or more other sub-headings and vice versa.

### Combined Atomic and Ordered Flow Processing in Load Balancer

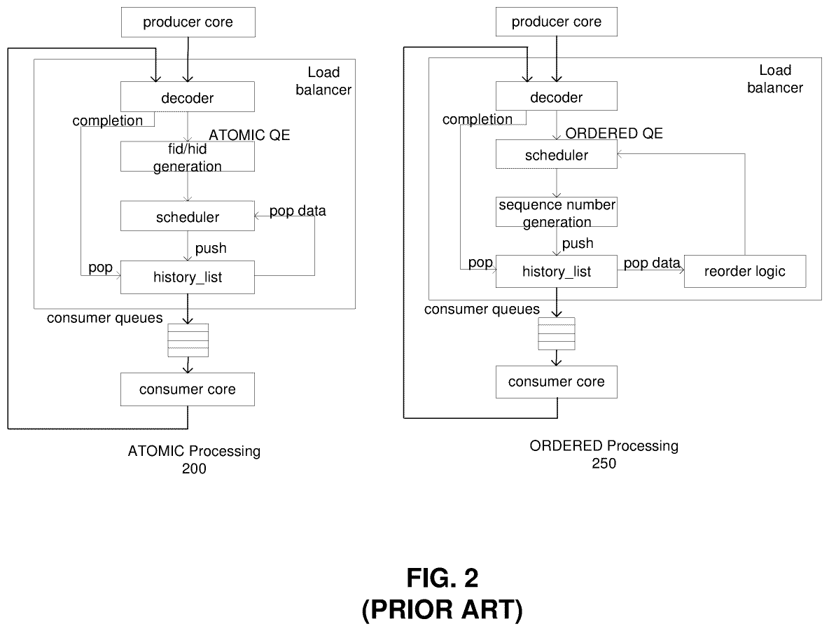

FIG. 2 depicts an example of ATOMIC and ORDERED operations of a load balancer. Load balancer can receive a flow with either an ATOMIC or ORDERED type and processes the flow. For the ATOMIC type 200, load balancer generates a flow identifier and makes an entry in a history list before scheduling the flow to a consumer queue. When the ATOMIC flow has completed, consumer core can send a completion to pop the history list to indicate completion of the ATOMIC flow. For the ORDERED type 250, load balancer generates a sequence number and makes an entry in a history list before scheduling the flow to a consumer queue. When the ORDERED flow has completed, consumer core can send a completion to pop the history list to indicate completion of the ORDERED flow, and indicates completion of the ORDERED flow when it becomes the oldest flow in the ORDERED flow history list.

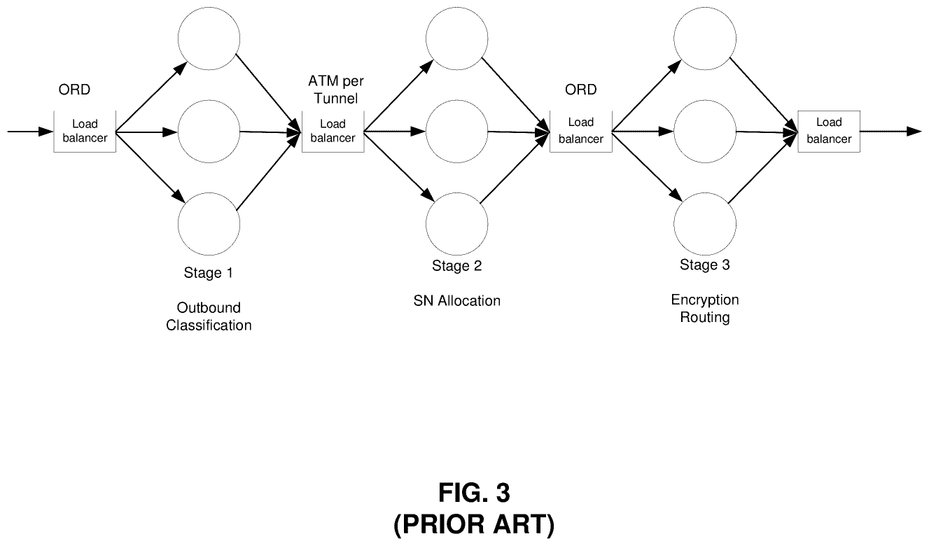

FIG. 3 depicts an example of processing of outbound communications using a load balancer. For example, outbound communications based on Internet Protocol Security (IPSec) can be performed over three stages of operations involving a load balancer. Stage 1 includes packet classification and packets do not have to be classified in order. Accordingly, classification can be done as an ORDERED load balancing operation. Packets are allowed to go out of order to different workers and load balancer can restore the order before the second stage (Stage 2). Stage 2 can include IPSec Sequence Number allocation to operate one multiple threads per tunnel and sequence number allocation can be distributed via an ATOMIC load balancing operation. Stage 3 includes ciphering and routing, which can be performed using ORDERED load balancing operation.

For application workloads, reducing a number of stages can reduce inter-stage information transfer overhead and increase central processing unit (CPU) availability. Moreover, reducing a number of stages can potentially reduce scheduling and queueing latencies and potentially reduce overall processing latency. In some examples, allocating processing to a single core can increase throughput and reduce latency to completion. Packets can be subjected to reduced number of queueing systems and reduced queueing and scheduling latency.

Various examples provide a load balancer processing a combined ATOMIC and ORDERED flow type. The load balancer can generate a flow identifier for the ATOMIC part and also generate a sequence number for the ORDERED part. A history list can store an entry for the ORDERED flow part and an auxiliary history list can store an entry for the ATOMIC flow part before the combined flow is scheduled to a consumer queue prior to execution. The consumer queue can send the ATOMIC completion to the load balancer when the stateful critical processing of the ATOMIC part is completed, followed by the ORDERED completion when the entire processing ORDERED flow part is completed. In response to receipt of both ATOMIC and ORDERED completions by the load balancer, the flow processing for the ATOMIC and ORDERED flow is completed.

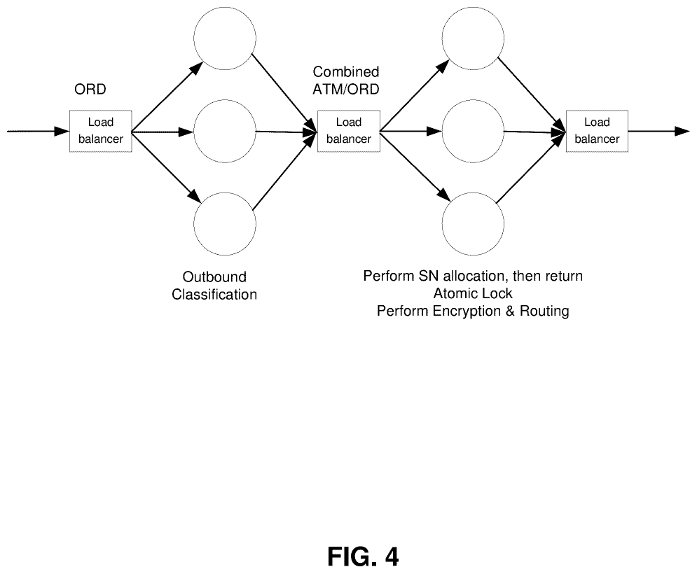

FIG. 4 depicts an example of processing of outbound communications that merges two stages. Stage 1 includes classification performed using an ORDERED flow in a load balancer stage. Stage 2 includes IPsec Sequence Number (SN) allocation, outbound IPsec protocol processing (including ciphering and integrity), and routing via combined ATOMIC and ORDERED flow in a load balancer. For the combined ATOMIC and ORDERED flow, load balancer can simultaneously generate a flow id for the ATOMIC part and a sequence number for the ORDERED part and make an entry in the history lists for both ATOMIC and ORDERED types. Software (e.g., a packet processing routine executed by a consumer code) can return a completion for the ATOMIC flow part and the completion for the ORDERED flow part. With this combined ATOMIC and ORDERED processing, a load balancer can process a flow once. By use of separate history lists, ATOMIC and ORDERED flows may pass through the load balancer a single time.

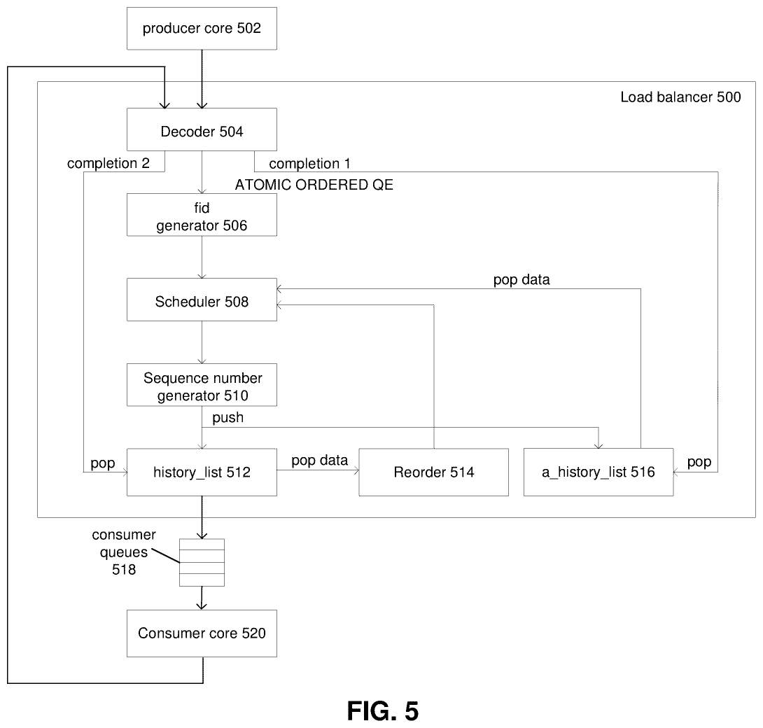

FIG. 5 depicts an example of combined ATOMIC and ORDERED flow processing by a load balancer 500. Producer core 502 can submit a queue element (QE) with command, queue type, and command as to how to process the QE. With an ATOMIC type and a per QID configuration, a flow can be identified as a combined ATOMIC+ORDERED type and processed as described herein. Decoder 504 can process the QE (e.g., command and queue type) to indicate ATOMIC type. In some examples, for an ATOMIC portion of a QE, flow identifier (fid) generator 506 can provide QE and flow identifier (fid) for the QE. Scheduler 508 can select a QE and associated fid to provide for execution of the QE. For an ORDERED part of the QE, sequence number generator 510 can generate a sequence number for the scheduled QE and associated fid. The sequence number can be used to represent a scheduling order of execution of QEs. For an ORDERED flow, sequence number generator 510 can place the sequence number in history_list 512. For an ATOMIC flow, sequence number generator 510 can place a fid for the QE in a_history_list 516. In some examples, history_list 512 can store a scheduling order of QEs by sequence number and can track service order of execution for an ORDERED flow. The combined ATOMIC+ORDERED flow can be provided to consumer queue 518.

QE and associated fid in history_list 512 can be provided to consumer queues 518 for performance by a consumer core 520 among multiple consumer cores. Consumer core 520 can send the indication of completion of an ATOMIC operation before sending indication of completion of an ORDERED operations. Consumer core 520 can indicate to decoder 504 completion of processing an ATOMIC QE in completion 1. Completion 1 can be indicated based on completion of stateful processing so another core can access shared state and a lock can be released. For IPsec, completion 1 can indicate a sequence number (SN) allocation is completed. Decoder 504 can remove (pop) an oldest fid entry in a_history_list 516 and can provide the oldest fid entry to scheduler 508 as a completed fid. Scheduler 508 can update state information with completed fid to determine what QE to schedule next.

Consumer core 520 can indicate to decoder 504 completion of processing an ORDERED QE with completion 2. For IPsec, completion 2 can indicate deciphering is completed. A sequence number for the processed QE can be removed (popped) from history_list 512. Reorder circuitry (not shown) can reorder QEs in history_list 512 based on sequence number values. Reorder circuitry can release a QE when an oldest sequence number arrives to allow sequence number to be reused by scheduler 508.

After completions for an ATOMIC operation and ORDERED operation are received by decoder 504, the flow processing has completed and entries in respective history_list 512 and a_history_list 516 can be popped or removed to free up space for other entries.

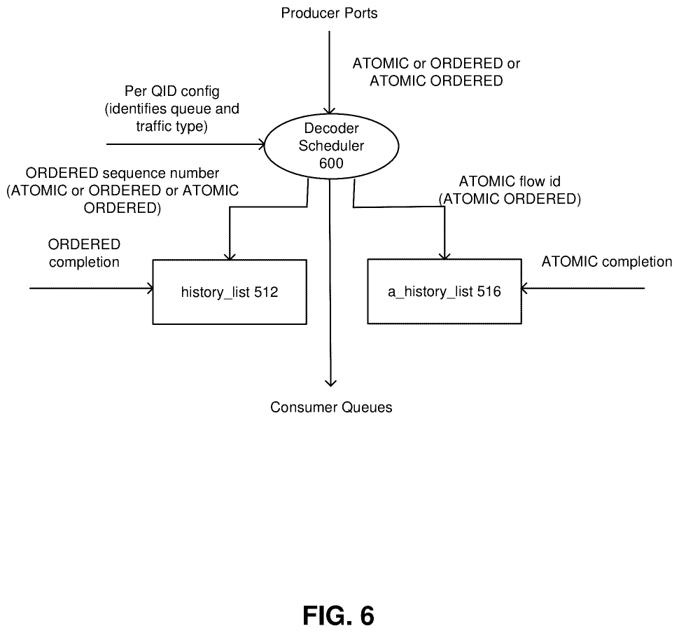

FIG. 6 depicts an example overview of ATOMIC, ORDERED and combined ATOMIC ORDERED flow processing. A producer port can provide an ATOMIC, ORDERED, or ATOMIC ORDERED QE for processing by the load balancer. Decoder scheduler 600 can identify the queue element as ATOMIC, ORDERED, or ATOMIC ORDERED QE based on per QID configuration that identifies queue and traffic type. Based on the QE including an ORDERED flow (e.g., ORDERED or ATOMIC ORDERED), decoder scheduler 600 can issue a sequence number for the QE into history_list 512 for submission to a consumer queue. Based on the QE including an ATOMIC flow (e.g., ATOMIC or ATOMIC ORDERED), decoder scheduler 600 can issue a flow identifier for the QE into a_history_list 516 for submission to a consumer queue. Indication of an ORDERED completion can cause the sequence number to be cleared from history_list 512. Indication of an ATOMIC completion can cause the flow identifier to be cleared from a_history_list 516.

A load balancer can maintain arrival packet ordering with early ATOMIC releases using a single stage. Early completion of a flow allows a flow to be migrated to another consumer queue if conditions allow (e.g., no other pending completions for the same flow and the new CQ is not full), potentially improving overall parallelization and load balancing efficiency.

### Power Aware Load Balancing

When a load balancer workload is light, a number of Consumer Queues (CQs) that serve the load balancer could be taken offline to allow those CQs to go idle and the cores servicing the idle CQs can be put in low or reduced power state. A load balancer can schedule tasks to available CQs regardless of the workload of the load balancer. However, some of the CQs may be underutilized.

The load balancer can allocate events to CQs in system memory to assign to a core for processing. Load balancer can enqueue events in internal queues, for example, if the CQs are full. Credits can be used to prevent internal queues from overflowing. For example, if there is space allocated for 100 events to an application, that application receives 100 credits to share among its threads. If a thread produces an event, the number of credits can be decremented and if a thread consumes an event, the number of credits can be incremented. Load balancer can maintain a copy of application credit count.

To attempt to reduce power consumption of cores associated with idle or underutilized CQs, the load balancer can take CQs offline based on available credits and programmable per-CQ high and low load levels. A credit can represent available storage inside the load balancer. A pool of storage can be divided into multiple domains for multiple simultaneously executing applications and a domain can be associated with multiple worker CQs. A number of queues associated with a core can be adjusted by changing a number of CQs (e.g., active, on, or off) allocated to a single domain.

When the workload is light, as indicated by the high number of available credits, some available CQs may be idle or underutilized and load balancer can selectively take some CQs offline to control a number of online active CQs. Idle or underutilized threads or cores can go into a low power state by the system (e.g., a power management thread executed by a core or associated with a CPU socket) when an associated CQ is idle or underutilized. Keeping a CQ inactive allows threads or cores to stay in a lower power state. When load balancer credits are above the high level, indicating a lower load, load balancer can take one or more CQ offline. However, when credits fall below the low level, indicating a higher load, load balancer can place the one or more CQ back online.

Load balancer can determine if a thread is needed or not and can stop sending traffic to a thread that is not needed. Such non-needed thread can consume allocated traffic and then detect its CQ is empty. The thread can execute an MWAIT on the next line to be written in the CQ and MWAIT can cause transition of a core executing the thread to a low power state. If load balancer determines the thread is to be utilized, the load balancer can resume writing to the CQ and a first such write to the CQ can trigger the thread to wake.

For example, for 1000 credits allocated to a domain and 600 QEs are queued for the domain, an amount of free credits=(total allocated−credits in use)=1000−600=400. When the free credits of this domain exceeds a particular CQ's high threshold level, the domain can be taken out of operation (e.g., light load) and put back in service when the free credits falls below lower threshold level (e.g., high load). In other words, load can be measured in terms of number of credits in use for the given domain.

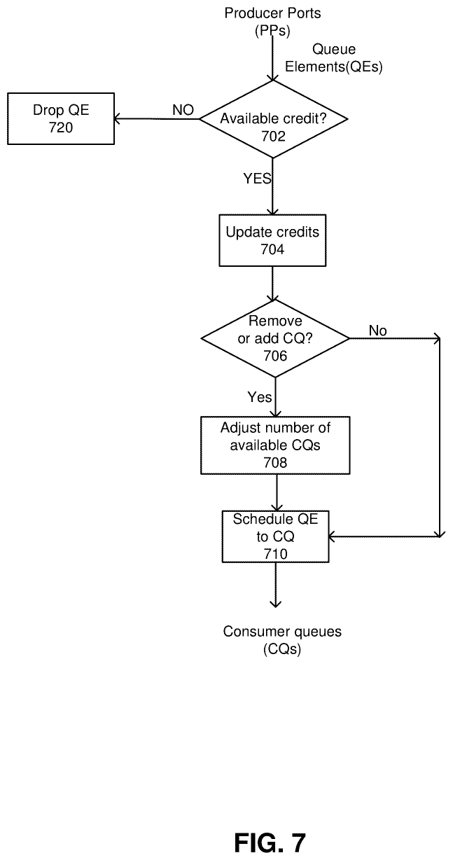

FIG. 7 depicts an example process. The process can be performed by a load balancer. Load balancer can receive Queue Elements (QEs) from Producer Ports (PPs) and validate the QEs. At 702, the load balancer can perform a credit check to determine if a number of available credits is greater than zero. At 702, based on insufficient credits being available, at 720, the QE can be dropped and an indication of dropped QE provided to a producer. Based on a sufficient number of credits being available (e.g., one or more credits), at 704, the number of credits can be updated to indicate allocation to a QE. Load balancer can update credits whereby when a QE is accepted by the load balancer, a credit is subtracted but when CQ pulls the QE, a single credit can be returned. For example, the number of credits can be reduced by one. At 706, a determination can be made as to whether to add or remove a CQ. For example, on a per CQ-basis (e.g., CQ domain), available credits can be checked against a high level. Available credits can represent a total number of credits allocated to a CQ domain less a number of credits in use for the CQ domain. Credit count can reflect a number of events queued up in load balancer that are waiting distribution and can indicate a number of threads to process the events where the more events that are enqueued, the more threads are to be allocated to process the events.

Total credit can include credits (T) allocated to a particular application. At a given moment, the application can be allocated N credits and the remainder are allocated to the load balancer for use, so the load balancer is capable to use T−N. Load balancer can track N and the count can decrement N when a new event is inserted by the application, or it could track (T−N) that will increment (T−N) when a new event is inserted.

At 708, based on the number of available credits for the CQ domain being above a high level, load balancer can take the CQ and associated core offline (e.g., decrease supplied power or decrease frequency of operation). As workload starts to build and the available credits for the CQ domain falls below a low level, at 708, load balancer can put the CQ and associated core back online (e.g., increase supplied power or increase frequency of operation). However, based on the available credits being neither above a high level or below a low level, the process can proceed to 710. At 710, the load balancer can schedule validated QEs to one or more of the available CQs.

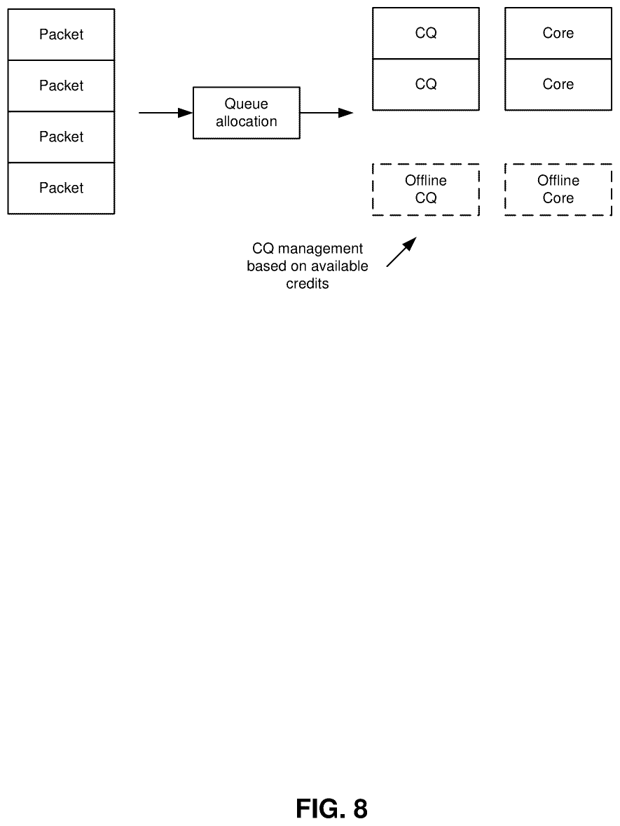

FIG. 8 depicts an example use case. Load balancer can buffer packets in memory for allocation to one or more CQs. Load balancer can determine a number of cores to keep powered up based on number of packets in queues and based on latency in an associated service level agreement (SLA) for the packets. A packet can include a header portion and a payload portion. In a load balancer, a determination can be made per-core of whether to reduce power or turn off a CQ based on a number of packets allocated in CQs for processing. For example, based on a number of available queues being less than a low level, the load balancer can cause at least one CQ and associated core to become inactive or enter reduced power mode.

### Load Balanced Queue Scaling in Load Balancer

In a load balancer, applications can use up to a configured number of supported QID scheduling slots. However, some applications utilize more per-CQ QID scheduling slots than supported or available in the load balancer. Accordingly, applications that attempt to utilize more QID slots than currently supported by the load balancer may not be able to utilize the load balancer. Adding more QID scheduling slots can incur additional silicon expenses. In some examples, to increase a number of available CQ QID, instead of adding more QID scheduling slots to a CQ, two or more CQs and their resources can be combined to provide at least two times a number of QID scheduling slots at the expense of reducing the number of CQs. A per-CQ programmable control register can specify to the load balancer whether the CQs operate in a combined mode. An application, operating system (OS), hypervisor, orchestrator, or datacenter administrator can set the control register to indicate whether the CQs operate in a combined mode or non-combined mode.

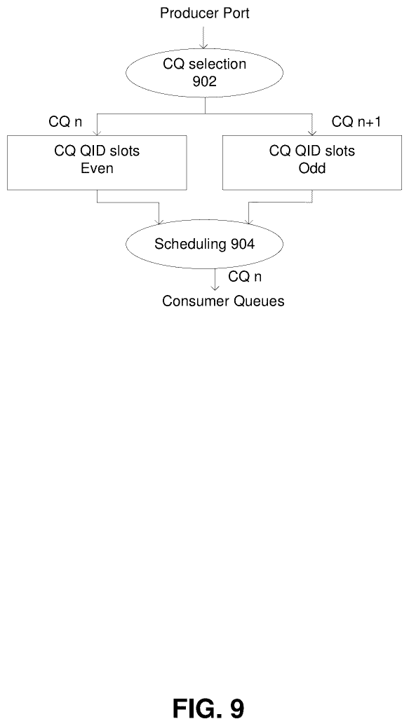

FIG. 9 depicts an example process. The process can be performed by a load balancer or other circuitry or software. At 902, a CQ selection can be performed. When operating in combined mode, the QID slots for CQ n and n+1 can be combined and the load balancer can perform QE scheduling decisions across the combined 2×QID slots. Instead of just accessing the QID slot memory for CQ n, both CQ n (even) and n+1 (odd) memories can be accessed simultaneously and in-paired CQ mode, at least two times a number of QID slots can be accessed by the load balancer to make a scheduling decision at 904.

In some examples of paired CQ mode, scheduled tasks can be allocated to the even CQs only and odd numbered CQ may not be utilized. In some examples of non-paired CQ mode, the even or odd QID slots can be used for scheduling decisions and the scheduled tasks can be provided to whichever CQs are originally selected.

### Producer Port Work Submission Re-Ordering in Intel Dynamic Load Balancer

In some Systems on Chip (SOC) implementations, a scalable interconnect fabric can be used to connect data producers (e.g., CPUs, accelerators, or other circuitry) with data consumers (e.g., CPUs, accelerators, or other circuitry). Where multiple cache devices and memory devices are utilized, some systems utilize Cache and Home Agents (CHAs) or Cache Agents (CAs) or Home Agents (HAs) to attempt to achieve data coherency so that a processor in a CPU socket receives a most up-to-date copy of content of a cache line that is to be modified by the processor. Note that references to a CHA can refer to a CA and/or HA as well. A hashing algorithm can be applied to the address memory for a memory-mapped I/O (MMIO) space access to route the access to one of several Cache and Home Agents (CHAs). Accordingly, writes to different MMIO space addresses can target different CHAs, and take different paths through a fabric from producer to consumer, with differing latencies.

If there are multiple equivalent producers and/or consumers in the SOC, producer/consumer pairs may be pseudo-randomly assigned at runtime based on the current SOC utilization. Therefore, different producers can potentially be paired with the same consumer during different runs of the same thread or application. System memory addresses mapped to a consumer can vary at runtime so that the fabric path between the same producer/consumer pair can also vary during different runs of the same thread or application. Because the paths through the fabric to a consumer can be different for different producers or different system memory space mappings and can therefore experience different latencies, the application's performance can vary by non-trivial amounts from execution-to-execution depending on these runtime assignments. For example, if the application is run on a producer/consumer pair that has a larger average latency through the fabric, it may experience degraded performance versus the same application being run on a producer/consumer pair that has a lower average latency through the fabric.

A load balancer as a consumer can interact with a producer by receiving Control Words (CWs), at least one of which represents a subtask that is to be completed by the thread or application running in the SOC. CWs can be written by the producer to specific addresses within the load balancer's allocated MMIO space referred to as producer ports (PPs). When a producer uses its assigned load balancer PP address(es) to write CWs to the load balancer, those CWs are written into the load balancer's input queues. The load balancer can then act as a producer itself and move those CWs from its input queues to one or more other consumers which can accomplish the tasks the CWs represent. When a producer uses just a single PP address for its CW writes to the load balancer, the writes to that PP are routed to the exact same CHA in the fabric. An ordering specification for many applications is that the writes issued from a thread in a producer to a consumer are to be processed in the same order they were originally issued, and this ordering can be enforced by common producers when such writes are to the same cache line (CL) address.

Some of the latency associated with the strictest ordering specification can be avoided by using weakly ordered direct move instructions (e.g., MOVDIR*) instead of MMIO writes, but some weaker ordering specification can still cause head of line blocking issues in the producer or the targeted CHA, based on different roundtrip latency to the targeted CHA. Head of line blocking can refer to output of a queue being blocked due to an element (e.g., write request) in the queue not proceeding and blocking other elements in the queue from proceeding. These issues can impact operation of the load balancer and overall system performance and throughput.

For an MMIO space access address decode, the load balancer can allow a producer to use several different cache line (CL) addresses to target the same PP. As different CLs may have different addresses and there are no ordering specification between weakly ordered direct move instructions to different addresses, by using more than one of these CL addresses for its writes, a producer can lessen the likelihood of head of line blocking issues in the producer. By spreading the write requests across multiple CHAs, the load on a CHA can be reduced, which can smooth or reduce the total roundtrip CHA latencies.

However, when multiple write requests to different CL addresses are used for the same PP, the write requests can take different paths through the mesh and, due to the differing latencies of the paths, write requests can arrive at the load balancer in an order different than they were issued. This can result in later-issued CL write requests being processed before earlier-issued CL write requests, which can cause applications to malfunction if the applications depend on the write requests being processed in the strict order they were issued. To fully support producers being able to make use of multiple CL addresses for a PP, a reordering operation can be performed in the consumer to put the PP writes back into the order in which they were originally issued before they are processed by the consumer.

If producers are to write into their PP CL address space as if it was a circular buffer (e.g., starting at the lowest CL address assigned for that PP, incrementing the CL address with a subsequent write for the same PP, and wrapping from the last assigned CL back to the first), then the address can provide the ordering information, and a buffer to perform reordering (e.g., reordering buffer (ROB)) can be utilized in the consumer's receive path to restore the original write issue ordering. The ROB can be large enough to store the number of writes for the unique CLs available in a PP that utilizes reordering support and can access the appropriate state and control to allow it to provide the writes to the consumer's downstream processor when the oldest CL write has been received. In other words, the ROB write storage can be written in any order, but it is read in strict order from oldest CL location to newest CL location to present the writes in their originally issued order. The combination of using weakly ordered direct move instructions and multiple PP CL addresses can be treated as a circular buffer in the producers, and the addition of the ROB in the consumers can reduce occurrences of head of line blocking issues in the producers and CHAs.

At least to address a potential ordering issue that can arise from differing latencies for accessing different CHAs, caching agents (CAs), or home agents (HAs), some examples allocate system memory address space to the load balancer to distribute CHA, CA, or HA work among different CHAs, CAs, or HAs and a consumer device can utilize a ROB. During enumeration of load balancer as PCIe or CXL device, system memory address space can be allocated to the load balancer to distributes CHA work among different CHAs to potentially reduce variation in latency through a mesh, on average. Note that reference to a CHA can refer to a CA and/or HA.

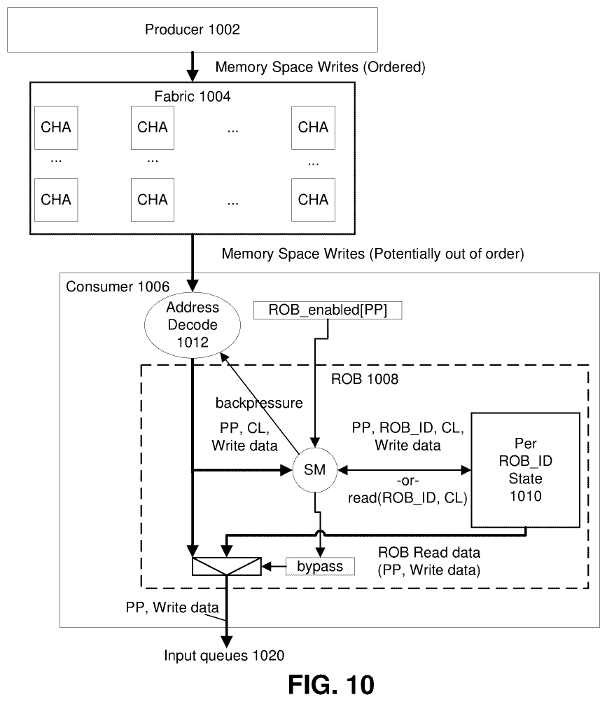

FIG. 10 depicts an example system. Producer 1002 can issue memory space write requests starting with address 0x100 and then in an incrementing circular fashion (0x140, 0x180, 0x1c0, 0x100, etc.) for a CL write. Fabric 1004 can forward the write requests to the Consumer 1006. Consumer 1006 (e.g., load balancer) can include a ROB 1008 to reorder received memory space writes, which can be potentially out of order due to different latencies through fabric 1004. In some examples, consumer 1006 can utilize circuitry described at least with respect to FIGS. 1A and/or 1B.

Per ROB_ID state can store the CL write data for up to N cache lines (e.g., N=4 in FIG. 10), a valid bit per cache line, a next expected cache line index, and the PP associated with that ROB_ID. During reset of consumer 1006, ROB state for a ROB_ID can be reset to 0, including the per CL valid bits (rob_cl_v[ROB_ID][*]) and the next expected CL index (rob_exp_cl[ROB_ID]) counter. The data and PP portions of the per ROB_ID state may not be reset.

Address decoder 1012 can provide a targeted PP and CL index based on the address provided with the write, and forward write data (e.g., data to be written) to ROB 1008.

ROB 1008 can receive a vector for a PP (e.g., ROB_enabled [PP]) that specifies whether or not the reordering capability is enabled for a PP. Different implementations could provide a one-to-one mapping between PP and ROB_ID or ROB_ID could be a function of PP depending on whether the reordering capability is to be supported for PPs or just a subset of PPs. In other words, if reordering is enabled for a particular PP, a ROB_ID associated with the PP can be made available.

If a PP does not have the reordering capability enabled (e.g., rob_enabled[PP]==0), then writes from that PP can be bypassed from the consumer's input to input queues 1020 as if the ROB did not exist in the path using the bypass signal to the multiplexer.

If reordering is enabled for a PP (e.g., rob_enabled[PP]==1), and the CL index for the write from that PP does not match the next expected CL index for the mapped ROB_ID, then the write is written into a ROB buffer 1008 at the mapped ROB_ID for that PP and CL index, the PP value is saved in rob_pp[ROB_ID], and the CL valid indication for that CL index (rob_cl_v[ROB_ID][CL]) is set to 1. If the CL index for the write matches the next expected CL value, then that write is bypassed to the consumer's input queues 1020 and the next expected CL value for the mapped ROB_ID is incremented. If the CL valid indication is set for the new next expected CL index value, then a read is initiated for the ROB data at that ROB_ID and CL index so it can be forwarded to the consumer's input queues 1020, the CL valid indication for that CL index is reset to 0, and the next expected CL index is again incremented. This process can continue as long as there is valid contiguous data still in ROB 1008 for that ROB_ID.

While ROB 1008 is being accessed to provide data to input queues 1020, the input address decode path can be back pressured as the input path or the ROB output path can drive the single output path (e.g., mux output) on a cycle.

To support more than one flow on a particular PP where one of the flows utilizes reordering by ROB 1008 but other flows do not utilize reordering, the number of CL addresses associated with the PP could be increased in address decoder 1012. For example, 5 CL addresses can be decoded for a PP where the first 4 CL address are contiguous. The flow that utilizes reordering could still treat the first four CL addresses as a circular buffer, while the flows that do not utilize reordering could use the fifth CL address. ROB 1008 can bypass PP writes that have a CL index greater than 3 as if rob_enabled[PP] was not set for that PP, even though it is set.

If the rob_enabled bit for a PP is reset after being set, this can be used as an indication to reset ROB state for the associated ROB_ID. This can be used for example, to clean up after any error condition, or as preparation for reinitializing the PP or reassigning the PP to a different producer.

This example was based on writes that were for an entire CL worth of data, but it can also be extended for writes that are for more or less than a CL by replacing the CL index with an index that reflects the write granularity.

If producer 1002 deviates from writing to its PP addresses in a circular buffer fashion or is allowed to have more outstanding writes at one time than ROB 1008 supports for a PP that has reordering enabled, ROB 1008 can see a write for a location it has already marked valid but not yet consumed.

### Load Balancer and Network Interface Device Communication

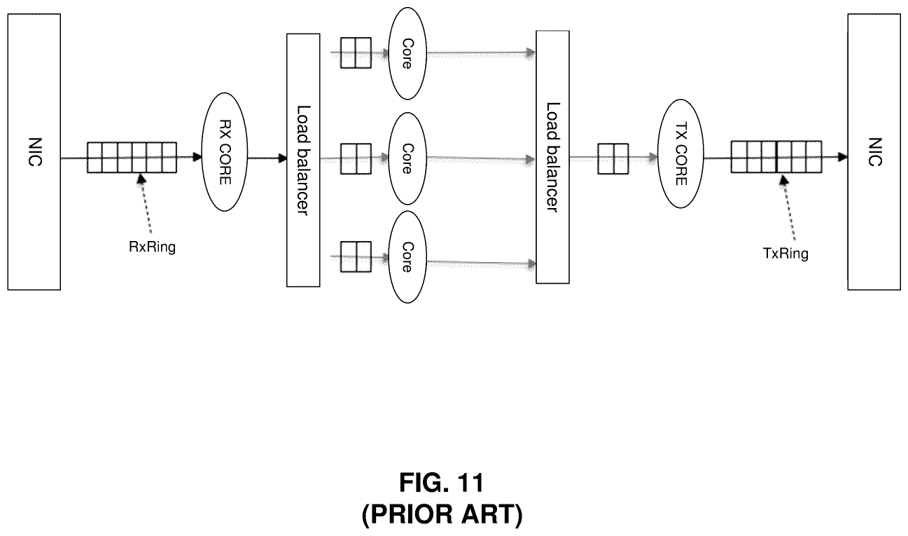

FIG. 11 depicts an example prior art flow. A load balancer can be used in multi-service deployments to handle rapid temporal load fluctuations across services, prioritized multi-core communication, ingress load balancing and traffic aggregation for efficient retransmission, and many other use cases. Load balancer can load balance ingress packet traffic from a network interface device or network interface controller (NIC) and aggregate this traffic for retransmission by the NIC. Load balancer can load balancing NIC traffic in a Data Plane Development Kit (DPDK) environment. Existing deployments utilize a network interface device that is independent from the load balancer and software threads bridge receipt of network interface device packets and load balancer events. A CPU core can execute a thread for buffer management. Threads RX CORE and TX CORE can manage NIC queues. Cores or threads labelled TX CORE and RX CORE pass traffic between the NIC and load balancer.

For example, RX CORE can perform: execute receive (Rx) Poll Mode Driver, consume and replenish NIC descriptors; convert NIC meta data to DPDK MBUF (e.g., buffer) format; poll Ethdev/Rx Queues for packets; update DPDK MBUF/packet if utilized; and load balance Eventdev producer operation to enqueue to load balancer.

For example, TX CORE can perform: load balance Eventdev consumer operation to dequeue to load balancer; congestion management; batch/buffer events as MBUFs (e.g., buffers) for legacy transmit or doorbell queue mode transmission; call Tx poll mode driver when batch is ready; process completions for transmitted packets; convert DPDK meta data to NIC descriptor format; and run Tx Poll Mode Driver, providing and recycling NIC descriptors and buffers.

Various examples allow a load balancer to interface directly with a network interface device and potentially remove the need for bridging threads executed on cores (e.g., RX CORE and TX CORE). Accordingly, fewer core resources can be used for bridging purposes and cache space used by RX CORE and TX CORE threads can be freed for other uses. In some cases, end-to-end latency and jitter can be reduced. Load balancer can provide prioritized servicing for processing of Rx traffic and egress congestion management for Tx queues.

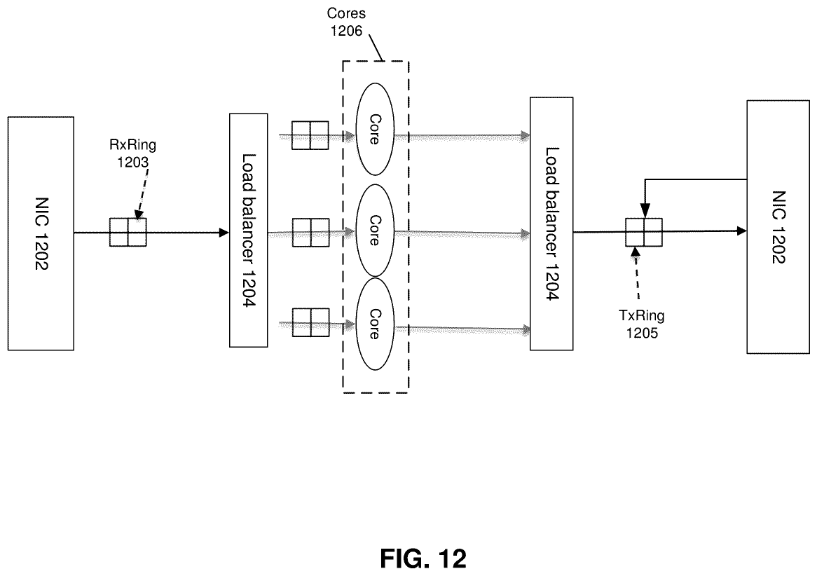

FIG. 12 depicts an example flow. NIC 1202 and load balancer 1204 can communicate directly on both Tx and Rx. In some examples, an SOC can include an integrated NIC 1202 and load balancer 1204. Note that reference to NIC 1202 can refer to one or more of: a network interface controller (NIC), a remote direct memory access (RDMA)-enabled NIC, SmartNIC, router, switch (e.g., top of rack (ToR) or end of row (EoR)), forwarding element, infrastructure processing unit (IPU), or data processing unit (DPU).

Load balancer 1204 can receive NIC Rx descriptors from RxRing 1203 and convert them to a format processed by load balancer 1204 without losing any data, instructions, or metadata. A packet may be associated with multiple descriptors on Tx/Rx, but load balancer 1204 may allow a single Queue Element per packet. Load balancer 1204 can process a different format for work elements where a packet is represented by a single Queue Element, which can store a single pointer. For load balancer 1204 to furnish the same information as that of a NIC descriptor, a load balancer descriptor can be utilized that load balancer 1204 creates on packet receipt (Rx) and processes on packet transmission (Tx).

For example, a sequence of events on packet Rx can be as follows. At (1), software (e.g., network stack, application, container, virtual machine, microservice, and so forth) can provide MBUFs (e.g., buffers) to load balancer 1204 for ingress (Rx) packets. At (2), load balancer 1204 can populate buffers as descriptors in the NIC RxRing 1203. At (3), NIC 1202 can receive a packet and write the packet to buffers identified by descriptors. At (4), NIC 1202 can write Rx descriptors to the Rx descriptor ring. At (5), load balancer 1204 can process Rx descriptors. At (6), load balancer 1204 can create load balancer descriptor (LBD) for the Rx packet and writes the LBD to MBUF. In some examples, an LBD is separate from a QE. At (7), load balancer 1204 can create a QE for the Rx packet and queue the QE internally and select a load balancer queue, to which the credit scheme applies, based on metadata in the NIC descriptor. Selecting a queue can be used to select what core(s) is to process a packet or event. A static configuration can allocate a particular internal queue to load balance its traffic across cores 0-9 (in atomic fashion) while a second queue might be load balanced across cores 6-15 (in ordered fashion) and cores 6-9 access events or traffic from both queues 11 and 12 in this example.

At (8), load balancer 1204 can schedule the QE to a worker thread. At (9), a worker thread can process the QE and access the MBUF in order to perform the software event driven packet processing.

For example, a sequence of events for packet transmission (Tx) can be as follows. At (1), processor-executed software (e.g., application, container, virtual machine, microservice, and so forth) that is to transmit a packet causes load balancer 1204 to create a load balancer descriptor if NIC offloads are utilized or the packet spans more than one buffer. If the packet spans just a single buffer, then processor-executed software can cause the load balancer to allocate a single buffer to the packet. At (2), processor-executed software can create a QE referencing the packet and enqueue the QE to load balancer 1204. The QE can contain a flag indicating if a load balancer descriptor (LBD) is present. At (3), the QE is enqueued to a load balancer direct queue that is reserved for NIC traffic. At (4), load balancer 1204 can process the QE, and potentially reorder the QE to meet order specifications before the QE reaches the head of the queue. At (5), load balancer 1204 can inspect the QE and read the LBD, if utilized. At (6), load balancer 1204 can write the necessary NIC Tx descriptors to transmit the packet. At (7), NIC 1202 can process the Tx descriptors to read and transmit the packet. At (8), NIC 1202 can write a completion for the packet. Such completion can be consumed by software or load balancer 1204, depending on which device is recycling the packet buffers.

In some examples, load balancer 1204 can store a number of buffers in a cache or memory and buffers in the cache or memory can be replenished by software or load balancer 1204. Buffer refill can be decoupled from packet processing and allow use of a stack based scheme (e.g., last in first out (LIFO)) to limit the amount of memory in use to what is actually utilized for data.

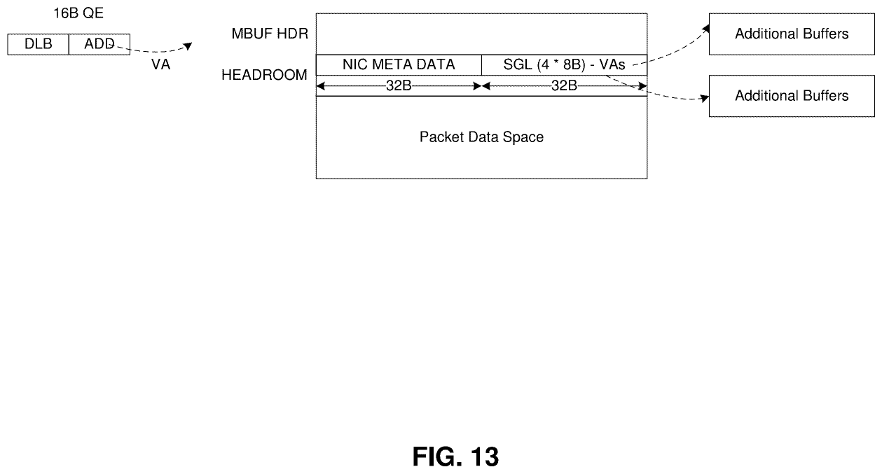

FIG. 13 depicts a load balancer descriptor (LBD) is shown as residing in the packet buffer structure. For example, an LBD can be stored in DPDK MBUF headroom. A 64 B (64 byte) structure can be split into 2×32B (32 byte) sections with one section for NIC metadata storage and one section for carrying 4 additional addresses (allowing a total of 5 buffers per packet). NIC metadata (e.g., 16/32 B) associated with a packet can be stored in the descriptor. On packet receipt, metadata can include information the NIC has extracted from the packet. Software can determine the Rx buffer address in one or more addresses from a history of buffers has supplied to the NIC Rx Ring. A scatter gather list (SGL) can refer to a chain of buffers associated with one or more packet data Virtual Addresses (VAs).

### A Stack Based Packet Memory Manager for a Load Balancer

In networking, software and hardware can be configured to perform packet processing. Software, application, or a device can perform packet processing based on one or more of Data Plane Development Kit (DPDK), Intel® Transport ADK (Application Development Kit), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in virtual execution environments. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Some applications can perform video processing or media transcoding (e.g., changing the encoding of audio, image or video files).

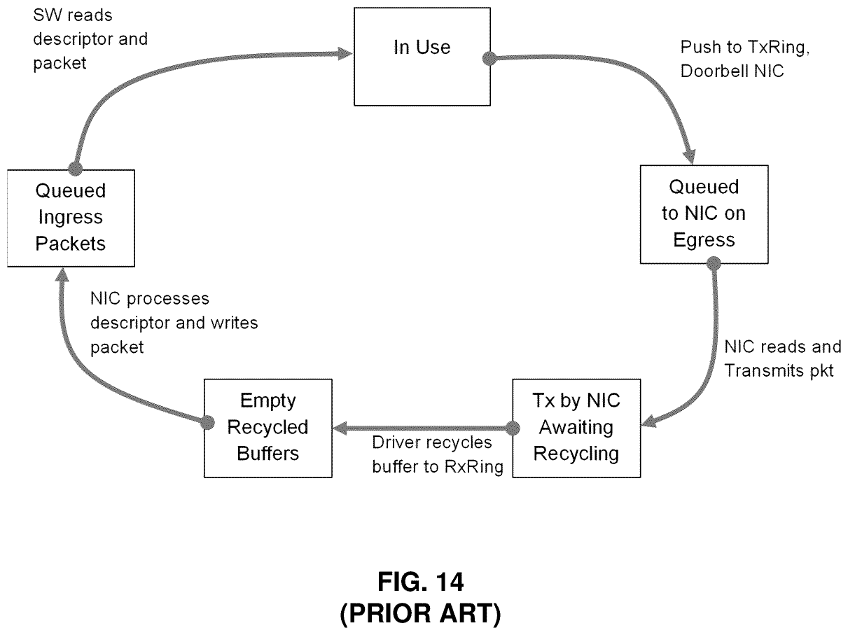

Packets can be assigned to buffers and buffer management is an integral part of packet processing. FIG. 14 depicts an example of buffer management life cycle such as for a run-to-completion application where multiple cores are available and one core of the multiple cores processes a packet. The example can be applied by an application based on DPDK, or other frameworks. A packet data footprint can be represented as a totality of buffers in active circulation. Packet processing applications tend to have a large memory footprint owing to the packet queuing specifications such as at network nodes with large bandwidth delay products and that apply quality of service (QoS) buffering.

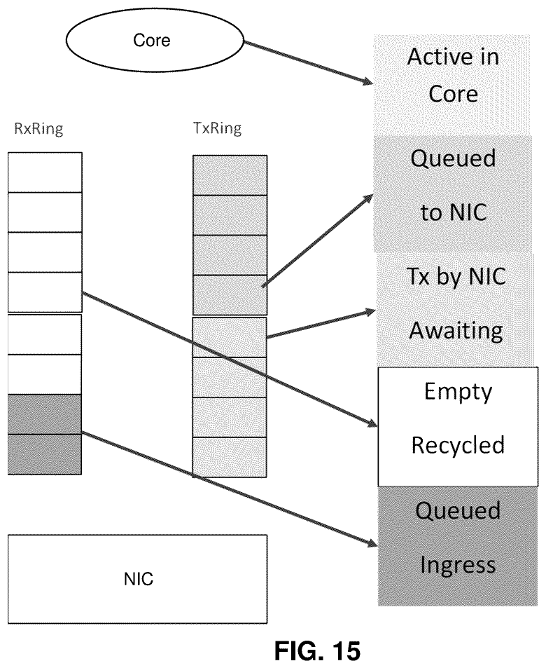

FIG. 15 depicts an example of buffer allocations. The size of the memory footprint involved is proportional to the length of the Tx/Rx rings and number of such ring pairs. A memory footprint can depend on total buffer size and a cache footprint can depend on the used buffer size, e.g., packet size. A packet processing application can maintain the Rx rings full of empty buffers to allow the Rx rings to absorb bursts of traffic. However, many of the allocated buffers may be actually empty and unused and yet have allocated memory. An application with a ring depth of 512 and an average packet size of 1 KB can have a footprint of 1 MB/thread, which is substantial in terms of the cache sizes. An application with utilization of more substantial ingress buffering can have a much higher memory footprint.

At least to attempt to reduce memory and cache utilization for ingress buffers, a load balancer can include circuitry, processor-executed software, and/or firmware to manage buffers. In an initial setup, software can allocate memory that is to store the buffers, pre-initialize the buffers (e.g., pre-initialize DPDK header fields), and store pointers to the buffers in a list in memory. The load balancer can be configured with the location/depth of the list. An application may offload buffer management to load balancer by issuance of an application program interface (API) or a configuration setting in a register. The load balancer can allocate a number of buffers in a last in first out (LIFO) manner to reduce a number of inflight buffers. Load balancer can replenish NIC RxRings, and reduce a need to maintain allocation of empty buffers and reduce a number of inflight buffers. Limiting an amount of free buffers on a ring can reduce a number of inflight buffers. Reducing a number of in-flight buffers can reduce a memory footprint size and can lead to fewer cache evictions, lower memory bandwidth usage, lower power consumption, and reduce latency for packet processing. The load balancer can be coupled directly to the network interface device (e.g., as part of an SOC).

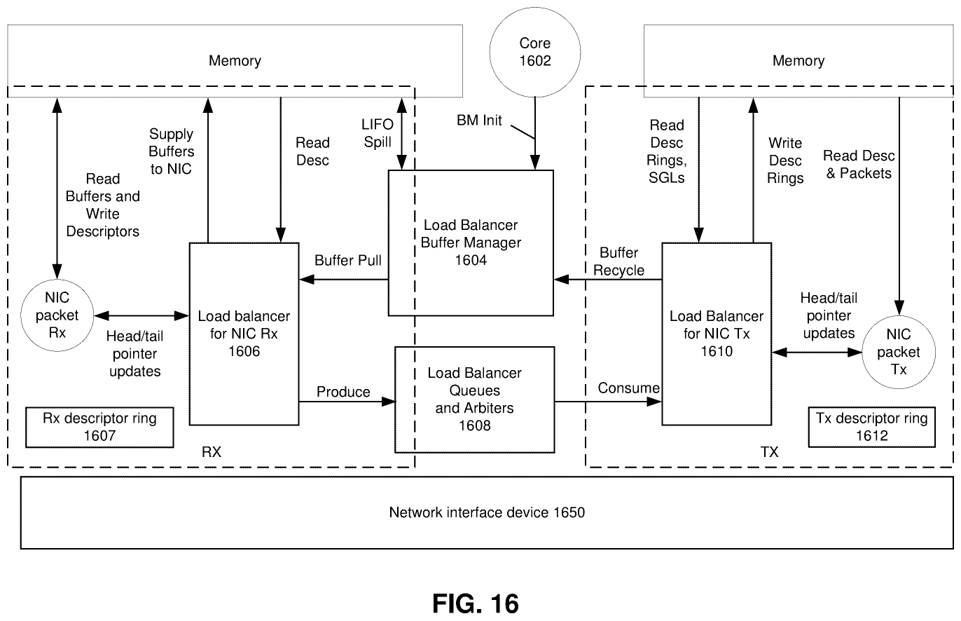

FIG. 16 depicts an example system. A load balancer buffer manager is to furnish buffers to a NIC on packet receipt (Rx), for received packets, whereas on packet transmit (Tx), based on the load balancer receiving a notification from the NIC that a packet has been transmitted, the load balancer can recycle buffers allocated to the transmitted packet. Elements such as load balancer buffer manager 1604, load balancer for NIC receipt (Rx) 1606, load balancer queues and arbiters 1608, load balancer for NIC transmit (Tx) 1610, and others can be utilized by a load balancer described herein at least with respect to FIGS. 1A and/or 1B.

An example of operations of a load balancer can be as follows. An application executing on core 1602 can issue buffer management initialization (BM Init) request to request load balancer buffer manager 1604 to manage buffers for the application. For packets received by network interface device 1650 (e.g., NIC), load balancer buffer manager 1604 can issue a buffer pull request to load balancer for NIC packet receipt (Rx) 1606 to request allocation of one or more buffers for one or more received packets. Load balancer 1606 can indicate to network interface device 1650 one or more buffers in memory are available for received packets. Network interface device 1650 can read descriptor(s) (desc) from memory in order to identify a buffer to write a received packet(s). Based on allocation of a packet received by network interface device 1650 to a buffer, load balancer 1606 can update head and tail pointers in Rx descriptor ring 1607 to identify newly received packet(s). For example, load balancer 1606 can poll a ring to determine if network interface device 1650 has written back a descriptor to indicate at least one buffer was utilized or network interface device 1650 can inform load balancer 1606 that a descriptor was written back to indicate at least one buffer was utilized. Network interface device 1650 can update the head pointer to a Rx descriptor ring 1607 and load balancer buffer manager 1604 uses the tail pointer. Load balancer could be informed, e.g. by head-writeback of received packets, and network interface device 1650 could be informed by tail update of empty buffers. Load balancer 1606 can issue a produce indication to load balancer queues and arbiters 1608 to indicate a buffer was utilized. An indication of Produce can cause the packet (e.g., one or more descriptors and buffers) to be entered into the load balancer to be load balanced.

Load balancer for queues and arbiters 1608 can issue a consume indication to load balancer for transmitted packets 1610 to request at least one buffer for a packet to be transmitted. Data can be associated with one or more descriptors and one or more packets, but for processing by load balancer, a single descriptor (QE) can be allocated per packet, which may span multiple buffers. Load balancer 1610 can read a descriptor ring and update a write descriptor to indicate an available buffer for a packet to be transmitted. Network interface device 1650 can transmit a packet allocated to a buffer based on a read transmit descriptor. On Tx, descriptors can be written by load balancer and read by network interface device 1650 whereas on Rx, descriptors can be written by a load balancer, read by network interface device 1650, and network interface device 1650 can write back descriptors to be read by load balancer 1610.

For packets transmitted by network interface device 1650, load balancer for transmitted packets 1610 can update read/write pointers in Tx descriptor ring 1612 to identify descriptors of packet(s) to be transmitted. In some examples, network interface device 1650 can identify the transmitted packets to the load balancer via an update. Load balancer for transmitted packets 1610 can issue a buffer recycle indication to load balancer buffer manager 1604 to permit re-allocation of a buffer to another received packet.

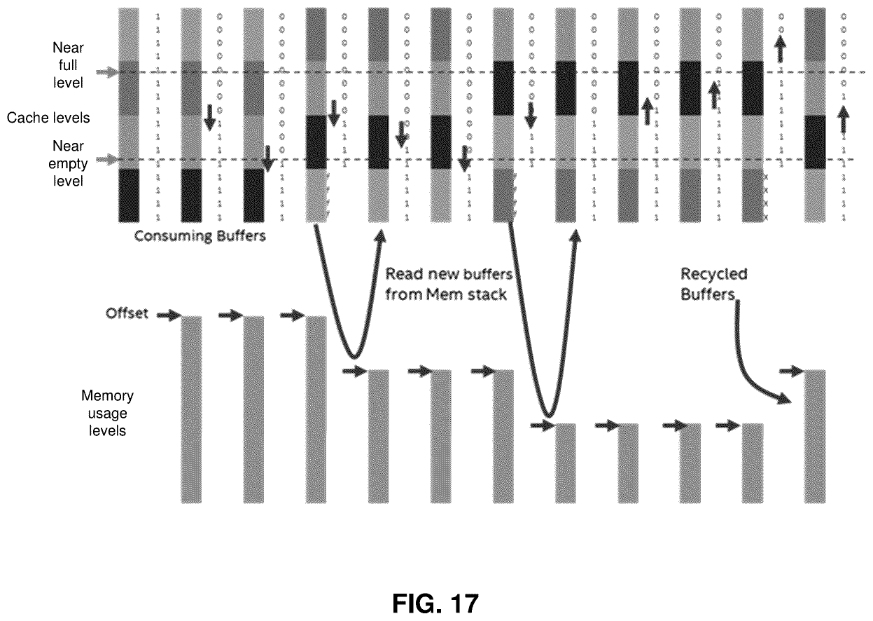

FIG. 17 depicts an example of a cache within the load balancer operates in a last in first out (LIFO) manner. Contents of the cache can be replenished from a memory stack by the load balancer when a level of buffers in the cache run low. The cache can be split into equally sized quadrants, or other numbers of equal or unequal sized segments. The cache can be associated with two watermark levels, namely, near-full and near-empty. Initially, the cache is full of buffers, as indicated by ‘1’ values.

As packet traffic received by a network interface device arrives into a load balancer, empty buffers are supplied to the NIC RxRing from the cache to replenish the NIC RxRing. Buffer consumption can cause entries to toggle from 1 (valid) to 0 (invalid). When a number of available buffers in the cache drops below the near-empty level, quadrants can be reordered to make space for new buffers while still preserving its LIFO order. An empty quadrant formerly at the top of the stack can be repositioned to the bottom and a read can be launched by the load balancer to fill the empty quadrant with valid buffers from system memory. The level of buffers in the cache can increase as a result.

If a rate of completions from transmitted packets increases and there is an increasing level of buffers in the cache, content of a low quadrant can be evicted to system memory or other memory. Whether or not a write has to occur can depend on whether these buffers were modified since read from the memory, and the now empty quadrant is repositioned to the top of the cache to allow more space for recycled buffers. Buffer recycling can be initiated by load balancer for NIC Tx 1610 when handling completions for transmitted packets from network interface device 1650. Network interface device 1650 can write completions to a completion ring which is memory mapped into load balancer for NIC Tx 1610 and load balancer for NIC Tx 1610 can parse the NIC TxRing for buffers to recycle based on receipt of a completion.

If an application drops a packet whose buffers were allocated by load balancer, the buffers is to be recycled. If an application is to transmit a packet whose buffers did not originate in load balancer, the buffer may not be recycled. These cases can be handled by flags within the load balancer event structure that an application is to send to load balancer for at least one packet. A 2 bit flag field can be referred to as DNR (Drop/Notify/Recycle).

| | | | Send | Recycle | |
|---|---|---|---|---|---|
| DNR | | SW Intent | to Tx | Buffers | Comment |
| 0 | 0 | Transmit packet | Yes | Yes | Transmit packet and recycle buffers. No |
| | | normally | | | notification to application. |
| 0 | 1 | Packet Buffers did | Yes | No | Packet transmitted, buffer not recycled. |
| | | not come from | | | The credit is used to send the notification. |
| | | load balancer. | | | Application can recoup this credit, which is |
| | | Application is to | | | thereafter returned to load balancer. |
| | | receive a | | | |
| | | notification for | | | |
| | | such a transmitted | | | |
| | | packet. | | | |
| 1 | 0 | Application | No | Yes | Packet dropped, buffers recycled. |
| | | dropped packet | | | |
| | | and is recycling | | | |
| | | buffers & | | | |
| | | returning credit. | | | |
| 1 | 1 | Application is | No | No | Accumulate credit only but do not recycle |
| | | returning a credit | | | buffer or transmit packet. |

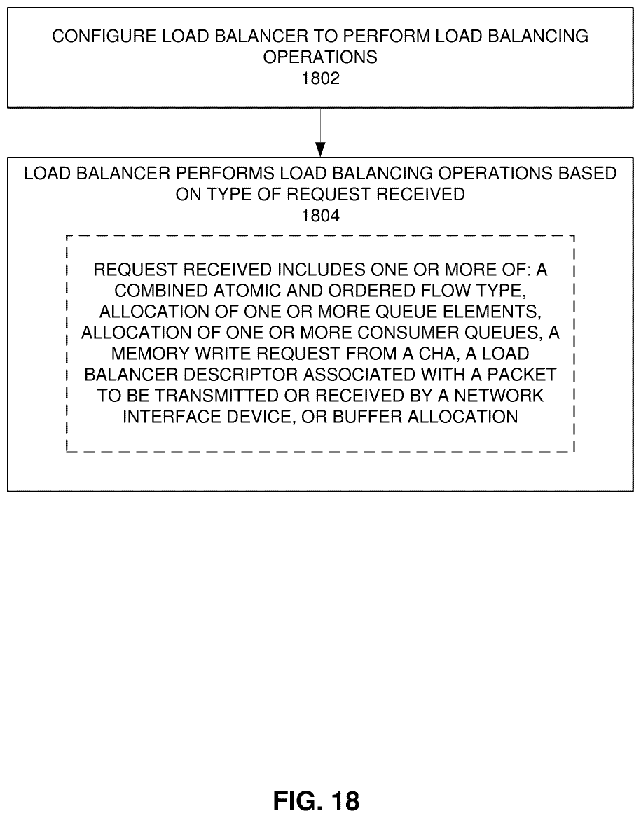

FIG. 18 depicts an example process. The process can be performed by a load balancer. At 1802, a load balancer can receive a configuration to perform offloaded tasks for software. Software can include an application, operating system (OS), driver, orchestrator, or other processes. For example, offloaded tasks can include one or more of: adjusting a number of queues associated with a core of the one or more cores by changing a number of consumer queues (CQs) allocated as a single CQ resource or domain, adjusting a number of target cores in a group of target cores to be load balanced, reordering memory space writes from multiple CHAs, processing a load balancer descriptor associated with load balancing packet transmission or receipt, managing a number of available buffers allocated to packets to be transmitted or received packets, or adjusting free buffer order in a load balancer cache.

At 1804, based on receipt of a request that is to be load balanced among other requests, the load balancer can perform load balancing of requests. In some examples, requests include one or more of: ATOMC flow type, ORDERED flow type, a combined ATOMIC and ORDERED flow type, allocation of one or more queue elements, allocation of one or more consumer queues, a memory write request from a CHA, a load balancer descriptor associated with a packet to be transmitted or received by a network interface device, or buffer allocation.

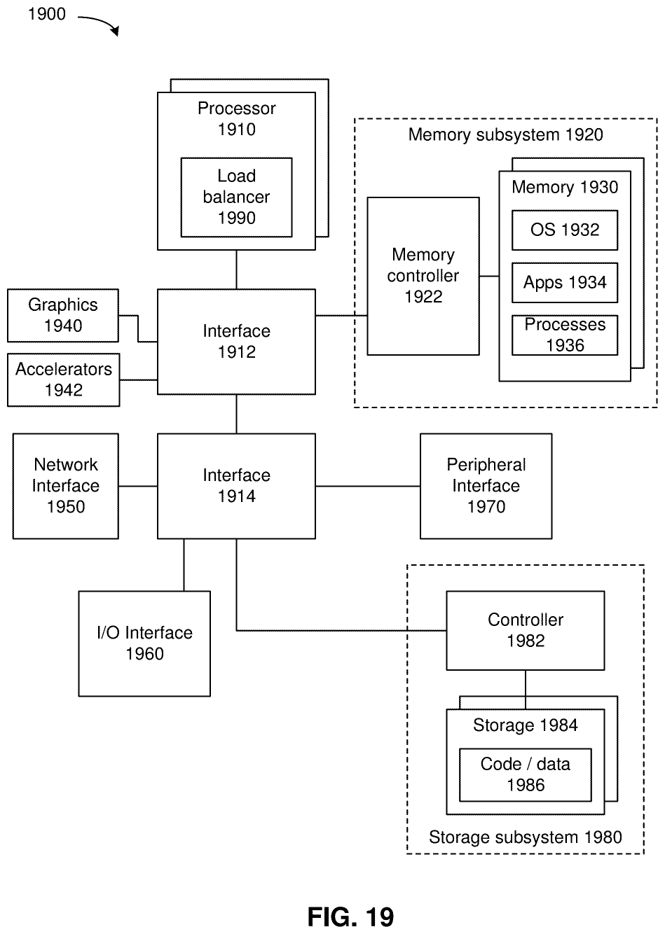

FIG. 19 depicts a system. In some examples, operation of processors 1910 and/or network interface 1950 can configured to utilize a load balancer, as described herein. Processor 1910 can include any type of microprocessor, central processing unit (CPU), graphics processing unit (GPU), XPU, processing core, or other processing hardware to provide processing for system 1900, or a combination of processors. An XPU can include one or more of: a CPU, a graphics processing unit (GPU), general purpose GPU (GPGPU), and/or other processing units (e.g., accelerators or programmable or fixed function FPGAs). Processor 1910 controls the overall operation of system 1900, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In some examples, processors 1910 can access load balancer circuitry 1990 to perform one or more of: adjusting a number of queues associated with a core of the one or more cores by changing a number of consumer queues (CQs) allocated as a single CQ resource or domain, adjusting a number of target cores in a group of target cores to be load balanced, reordering memory space writes from multiple CHAs, processing a load balancer descriptor associated with load balancing packet transmission or receipt, managing a number of available buffers allocated to packets to be transmitted or received packets, or adjusting free buffer order in a load balancer cache, as described herein. While load balancer circuitry 1990 is depicted as part of processors 1910, load balancer circuitry 1990 can be accessed via a device interface or other interface circuitry.

In some examples, system 1900 includes interface 1912 coupled to processor 1910, which can represent a higher speed interface or a high throughput interface for system components that needs higher bandwidth connections, such as memory subsystem 1920 or graphics interface components 1940, or accelerators 1942. Interface 1912 represents an interface circuit, which can be a standalone component or integrated onto a processor die. Where present, graphics interface 1940 interfaces to graphics components for providing a visual display to a user of system 1900. In some examples, graphics interface 1940 can drive a display that provides an output to a user. In some examples, the display can include a touchscreen display. In some examples, graphics interface 1940 generates a display based on data stored in memory 1930 or based on operations executed by processor 1910 or both. In some examples, graphics interface 1940 generates a display based on data stored in memory 1930 or based on operations executed by processor 1910 or both.

Accelerators 1942 can be a programmable or fixed function offload engine that can be accessed or used by a processor 1910. For example, an accelerator among accelerators 1942 can provide data compression (DC) capability, cryptography services such as public key encryption (PKE), cipher, hash/authentication capabilities, decryption, or other capabilities or services. In some embodiments, in addition or alternatively, an accelerator among accelerators 1942 provides field select controller capabilities as described herein. In some cases, accelerators 1942 can be integrated into a CPU socket (e.g., a connector to a motherboard or circuit board that includes a CPU and provides an electrical interface with the CPU). For example, accelerators 1942 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 1942 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 1920 represents the main memory of system 1900 and provides storage for code to be executed by processor 1910, or data values to be used in executing a routine. Memory subsystem 1920 can include one or more memory devices 1930 such as read-only memory (ROM), flash memory, one or more varieties of random access memory (RAM) such as DRAM, or other memory devices, or a combination of such devices. Memory 1930 stores and hosts, among other things, operating system (OS) 1932 to provide a software platform for execution of instructions in system 1900. Additionally, applications 1934 can execute on the software platform of OS 1932 from memory 1930. Applications 1934 represent programs that have their own operational logic to perform execution of one or more functions. Processes 1936 represent agents or routines that provide auxiliary functions to OS 1932 or one or more applications 1934 or a combination. OS 1932, applications 1934, and processes 1936 provide software logic to provide functions for system 1900. In some examples, memory subsystem 1920 includes memory controller 1922, which is a memory controller to generate and issue commands to memory 1930. It will be understood that memory controller 1922 could be a physical part of processor 1910 or a physical part of interface 1912. For example, memory controller 1922 can be an integrated memory controller, integrated onto a circuit with processor 1910.

Applications 1934 and/or processes 1936 can refer instead or additionally to a virtual machine (VM), container, microservice, processor, or other software. Various examples described herein can perform an application composed of microservices.

A virtualized execution environment (VEE) can include at least a virtual machine or a container. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from another, allowing virtual machines to run Linux®, Windows® Server, VMware ESXi, and other operating systems on the same underlying physical host. In some examples, an operating system can issue a configuration to a data plane of network interface 1950.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers may be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container.

In some examples, OS 1932 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others. In some examples, OS 1932 or driver can configure a load balancer, as described herein.

While not specifically illustrated, it will be understood that system 1900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In some examples, system 1900 includes interface 1914, which can be coupled to interface 1912. In some examples, interface 1914 represents an interface circuit, which can include standalone components and integrated circuitry. In some examples, multiple user interface components or peripheral components, or both, couple to interface 1914. Network interface 1950 provides system 1900 the ability to communicate with remote devices (e.g., servers or other computing devices) over one or more networks. Network interface 1950 can include an Ethernet adapter, wireless interconnection components, cellular network interconnection components, USB (universal serial bus), or other wired or wireless standards-based or proprietary interfaces. Network interface 1950 can transmit data to a device that is in the same data center or rack or a remote device, which can include sending data stored in memory. Network interface 1950 can receive data from a remote device, which can include storing received data into memory. In some examples, network interface 1950 or network interface device 1950 can refer to one or more of: a network interface controller (NIC), a remote direct memory access (RDMA)-enabled NIC, SmartNIC, router, switch (e.g., top of rack (ToR) or end of row (EoR)), forwarding element, infrastructure processing unit (IPU), or data processing unit (DPU). An example IPU or DPU is described at least with respect to FIG. 12.

Network interface 1950 can include a programmable pipeline (not shown). Configuration of operation of programmable pipeline, including its data plane, can be programmed based on one or more of: one or more of: Protocol-independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, x86 compatible executable binaries or other executable binaries, or others.

In some examples, system 1900 includes one or more input/output (I/O) interface(s) 1960. Peripheral interface 1970 can include any hardware interface not specifically mentioned above. Peripherals refer generally to devices that connect dependently to system 1900. A dependent connection is one where system 1900 provides the software platform or hardware platform or both on which operation executes, and with which a user interacts.

In some examples, system 1900 includes storage subsystem 1980 to store data in a nonvolatile manner. In some examples, in certain system implementations, at least certain components of storage 1980 can overlap with components of memory subsystem 1920. Storage subsystem 1980 includes storage device(s) 1984, which can be or include any conventional medium for storing large amounts of data in a nonvolatile manner, such as one or more magnetic, solid state, or optical based disks, or a combination. Storage 1984 holds code or instructions and data 1986 in a persistent state (e.g., the value is retained despite interruption of power to system 1900). Storage 1984 can be generically considered to be a “memory,” although memory 1930 is typically the executing or operating memory to provide instructions to processor 1910. Whereas storage 1984 is nonvolatile, memory 1930 can include volatile memory (e.g., the value or state of the data is indeterminate if power is interrupted to system 1900). In some examples, storage subsystem 1980 includes controller 1982 to interface with storage 1984. In some examples controller 1982 is a physical part of interface 1914 or processor 1910 or can include circuits or logic in both processor 1910 and interface 1914. A volatile memory is memory whose state (and therefore the data stored in it) is indeterminate if power is interrupted to the device. A non-volatile memory (NVM) device is a memory whose state is determinate even if power is interrupted to the device.

In an example, system 1900 can be implemented using interconnected compute nodes of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; chiplet-to-chiplet communications; circuit board-to-circuit board communications; and/or package-to-package communications. A die-to-die communications can utilize Embedded Multi-Die Interconnect Bridge (EMIB) or an interposer.

In an example, system 1900 can be implemented using interconnected compute sleds of processors, memories, storages, network interfaces, and other components. High speed interconnects can be used such as PCIe, Ethernet, or optical interconnects (or a combination thereof).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least some examples may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples and includes an apparatus that includes: an interface and circuitry, coupled to the interface, the circuitry to perform load balancing of requests received from one or more cores in a central processing unit (CPU), wherein: the circuitry comprises: first circuitry to selectively perform ordering of requests from the one or more cores, second circuitry to allocate the requests into queue elements prior to allocation to one or more receiver cores of the one or more cores to process the requests, and third circuitry to perform: adjust a number of queues associated with a core of the one or more cores by changing a number of consumer queues (CQs) allocated to a single domain and adjust a number of target cores in a group of target cores to be load balanced.

Example 2 includes one or more examples, wherein the requests comprise one or more of: a combined ATOMIC and ORDERED flow type, a load balancer descriptor, or a memory write request.

Example 3 includes one or more examples, wherein the adjust a number of queues associated with a core by changing a number of CQs allocated to a single domain comprises adjust a number of queue identifiers (QIDs) associated with the core.

Example 4 includes one or more examples, wherein based on reduction of workload to a core removed from the group of cores, reduce power to the core removed from the group of cores.

Example 5 includes one or more examples, wherein the third circuitry is to order memory space writes from multiple caching agents (CAs) prior to output to a consumer core and load balance memory write requests from multiple home agents (HAs).

Example 6 includes one or more examples, wherein the third circuitry is to process a load balancer descriptor associated with a packet transmission or packet receipt.

Example 7 includes one or more examples, wherein the third circuitry is to manage buffer allocation.

Example 8 includes one or more examples, and includes the CPU communicatively coupled to the circuitry to perform load balancing of requests.

Example 9 includes one or more examples, and includes a server comprising the CPU, the circuitry to perform load balancing of requests, and a network interface device, wherein the circuitry to perform load balancing of requests is to load balance operations of the network interface device.

Example 10 includes one or more examples, and includes a method that includes: in a load balancer: selectively performing ordering of requests from one or more cores, allocating the requests into queue elements prior to allocation to one or more receiver cores of the one or more cores to process the requests, and performing operations of: adjusting a number of queues associated with a core of the one or more cores by changing a number of consumer queues (CQs) allocated to a single domain and adjusting a number of target cores in a group of target cores to be load balanced.

Example 11 includes one or more examples, wherein the requests comprise one or more of: a combined ATOMIC and ORDERED flow type, a load balancer descriptor, or a memory write request.

Example 12 includes one or more examples, wherein the adjusting a number of queues associated with a core by changing a number of CQs allocated to a single domain comprises adjusting a number of queue identifiers (QIDs) associated with the core.

Example 13 includes one or more examples, wherein the performing the operations comprises ordering memory space writes from multiple caching agents (CAs) prior to output to a consumer core and load balancing memory write requests from multiple home agents.

Example 14 includes one or more examples, and includes the load balancer processing a load balancer descriptor associated with a packet transmission or packet receipt.

Example 15 includes one or more examples, and includes the load balancer managing allocation of packet buffers for an application.

Example 16 includes one or more examples, and includes at least one computer-readable medium comprising instructions stored thereon, that if executed by one or more processors, cause the one or more processors to: configure a load balancer to perform offloaded operations from an application, wherein: the load balancer is to selectively perform ordering of requests from one or more cores, the load balancer is to allocate the requests into queue elements prior to allocation to one or more receiver cores of the one or more cores to process the requests, and the offloaded operations comprise: adjust a number of queues associated with a core of the one or more cores by changing a number of consumer queues (CQs) allocated to a single domain and adjust a number of target cores in a group of target cores to be load balanced.

Example 17 includes one or more examples, wherein the requests comprise one or more of: a combined ATOMIC and ORDERED flow type, a load balancer descriptor, or a memory write request.

Example 18 includes one or more examples, wherein the adjust a number of queues associated with a core by changing a number of CQs allocated to a single domain comprises adjust a number of queue identifiers (QIDs) associated with the core.

Example 19 includes one or more examples, wherein based on reduction of workload to a core removed from the group of cores, reduce power to the core removed from the group of cores.

Example 20 includes one or more examples, wherein the perform the operations comprises order memory space writes from multiple caching agents (CAs) prior to output to a consumer core and load balance memory write requests from multiple home agents.

What is claimed is:

1. An apparatus comprising:
an interface and
circuitry, coupled to the interface, the circuitry to perform load balancing of requests received from one or more cores in a central processing unit (CPU), wherein:
the circuitry comprises:
first circuitry to selectively perform ordering of requests from the one or more cores,
second circuitry to allocate the requests into queue elements prior to allocation to one or more receiver cores of the one or more cores to process the requests, and
third circuitry to perform:
adjust a number of queues associated with a core of the one or more cores by changing a number of consumer queues (CQs) allocated to a single domain and
adjust a number of target cores in a group of target cores to be load balanced.

2. The apparatus of claim 1, wherein the requests comprise one or more of: a combined ATOMIC and ORDERED flow type, a load balancer descriptor, or a memory write request.

3. The apparatus of claim 1, wherein the adjust a number of queues associated with a core by changing a number of CQs allocated to a single domain comprises adjust a number of queue identifiers (QIDs) associated with the core.

4. The apparatus of claim 1, wherein based on reduction of workload to a core removed from the group of cores, reduce power to the core removed from the group of cores.

5. The apparatus of claim 1, wherein the third circuitry is to order memory space writes from multiple caching agents (CAs) prior to output to a consumer core and load balance memory write requests from multiple home agents (HAs).

6. The apparatus of claim 1, wherein the third circuitry is to process a load balancer descriptor associated with a packet transmission or packet receipt.

7. The apparatus of claim 1, wherein the third circuitry is to manage buffer allocation.

8. The apparatus of claim 1, comprising the CPU communicatively coupled to the circuitry to perform load balancing of requests.

9. The apparatus of claim 8, comprising a server comprising the CPU, the circuitry to perform load balancing of requests, and a network interface device, wherein the circuitry to perform load balancing of requests is to load balance operations of the network interface device.

10. A method comprising:
in a load balancer:
selectively performing ordering of requests from one or more cores,
allocating the requests into queue elements prior to allocation to one or more receiver cores of the one or more cores to process the requests, and
performing operations of:
adjusting a number of queues associated with a core of the one or more cores by changing a number of consumer queues (CQs) allocated to a single domain and
adjusting a number of target cores in a group of target cores to be load balanced.

11. The method of claim 10, wherein the requests comprise one or more of: a combined ATOMIC and ORDERED flow type, a load balancer descriptor, or a memory write request.

12. The method of claim 10, wherein the adjusting a number of queues associated with a core by changing a number of CQs allocated to a single domain comprises adjusting a number of queue identifiers (QIDs) associated with the core.

13. The method of claim 10, wherein the performing the operations comprises ordering memory space writes from multiple caching agents (CAs) prior to output to a consumer core and load balancing memory write requests from multiple home agents.

14. The method of claim 10, comprising the load balancer processing a load balancer descriptor associated with a packet transmission or packet receipt.

15. The method of claim 10, comprising the load balancer managing allocation of packet buffers for an application.

16. At least one computer-readable medium comprising instructions stored thereon, that if executed by one or more processors, cause the one or more processors to:
configure a load balancer to perform offloaded operations from an application, wherein:
the load balancer is to selectively perform ordering of requests from one or more cores,
the load balancer is to allocate the requests into queue elements prior to allocation to one or more receiver cores of the one or more cores to process the requests, and
the offloaded operations comprise:
adjust a number of queues associated with a core of the one or more cores by changing a number of consumer queues (CQs) allocated to a single domain and
adjust a number of target cores in a group of target cores to be load balanced.

17. The computer-readable medium of claim 16, wherein the requests comprise one or more of: a combined ATOMIC and ORDERED flow type, a load balancer descriptor, or a memory write request.

18. The computer-readable medium of claim 16, wherein the adjust a number of queues associated with a core by changing a number of CQs allocated to a single domain comprises adjust a number of queue identifiers (QIDs) associated with the core.

19. The computer-readable medium of claim 16, wherein based on reduction of workload to a core removed from the group of cores, reduce power to the core removed from the group of cores.

20. The computer-readable medium of claim 16, wherein the perform the operations comprises order memory space writes from multiple caching agents (CAs) prior to output to a consumer core and load balance memory write requests from multiple home agents.
